(19) United States
(12) Patent Application Publication
(10) Pub. No.: US 2007/0271021 A1
(43) Pub. Date: Nov. 22, 2007

(54) Method for Compensating for Gradient Influence When Determining a Reference Velocity

(75) Inventors: Gerold Schneider, Ebsdorfergrund (DE); Roland Caspari, Frankfurt/M (DE)

Correspondence Address: CONTINENTAL TEVES, INC., ONE CONTINENTAL DRIVE, AUBURN HILLLS, MI, 48326-1581, US

(73) Assignee: Continental Teves AG & Co. oHG, Frankfurt am Main (DE)

(21) Appl. No.: 11/596,440

(22) PCT Filed: May 10, 2005
(86) PCT No.: PCT/EP05/52124

§ 371 Date: Jun. 21, 2007

(30) Foreign Application Priority Data
May 14, 2004 (DE) 10 2004 024 458.8

(51) Int. Cl. G06F 17/00

(52) U.S. Cl. 701/94

(57) ABSTRACT

Disclosed is a method and a computer program product for compensating for gradient influence when determining a reference velocity. The method includes determining a controller nominal torque (M_{Rnominal}) in a vehicle controller (1) from at least one actual wheel speed (v_{wheel-actual}) and one predefined nominal wheel speed (V_{wheel-nominal}), determining a feedback torque (M_{feedback}), which is proportional to an estimated roadway gradient (\dot{ω}_{wheel}−\dot{ω}_{longit.}), calculating an engine nominal torque (M_{Mnominal}) from the controller nominal torque (M_{Rnominal}) and the feedback torque (M_{feedback}), and sending the engine nominal torque (M_{Mnominal}) to a vehicle controlled system (2) for determining the actual wheel speed (v_{wheel-actual}) from the engine nominal torque (M_{Mnominal}).

### BACKGROUND OF THE INVENTION

The present invention relates to a method for compensating for gradient influence when determining a reference velocity, in particular in all-wheel vehicles. The method includes determining a controller nominal torque (M_{Rnominal}) in a vehicle controller (1) from at least one actual wheel speed (v_{wheel-actual}) and one predefined nominal wheel speed (v_{wheel-nominal}), determining a feedback torque (M_{feedback}), which is proportional to an estimated roadway gradient (\dot{ω}_{wheel}−\dot{ω}_{longit.}), calculating an engine nominal torque (M_{Mnominal}) from the controller nominal torque (M_{Rnominal}) and the feedback torque (M_{feedback}), and sending the engine nominal torque (M_{Mnominal}) to a vehicle controlled system (2) for determining the actual wheel speed (v_{wheel-actual}) from the engine nominal torque (M_{Mnominal}). Also, a computer program product defines an algorithm that comprises this method.

Modern motor vehicles are equipped with most various electronic systems such as an anti-lock system (ABS), electronic stability program (ESP), traction slip control (TCS, BTCS) etc., for regulating and controlling the driving performance. One important coefficient of influence of these systems is the vehicle reference velocity. In vehicles with only one driven axle the vehicle reference velocity is usually determined from the wheel rotational behavior of the non-driven wheels, since the non-driven wheels do not exhibit wheel slip, with the result that the wheel speeds of the non-driven wheels correspond to the vehicle velocity. In all-wheel vehicles it is much more difficult to determine the vehicle reference velocity, because many factors, among others the gradient of the roadway, have an influence on the vehicle reference velocity.

German patent DE 199 11 525 C1 discloses a method and a device for determining a reference quantity for the wheel speeds of a vehicle, in particular with all-wheel drive. In addition, DE 197 32 554 A1 discloses a method and a device for determining the velocity of a vehicle for the case that all wheels of a vehicle are spinning, that means, they are accelerated to an extent greater than the vehicle acceleration itself.

In WO 03/068573 A2 a method for determining a gradient for all-wheel-driven vehicles is described, and the vehicle velocity is determined from the difference between the wheel acceleration and the measured longitudinal acceleration. Driving situations may occur in which the gradient is possibly learnt in an incorrect way. For example, the wheel accelerations that occur when accelerating a vehicle on a low coefficient of friction can cause wrong learning of a gradient. For this reason, only differential values of wheel and longitudinal acceleration have previously been used for estimating the gradient, whose change is insignificant. The evaluation of the change will fail if the wheels on a low coefficient of friction exhibit slowly rising wheel slip. This causes learning a gradient due to the insignificant change, although it should not be learnt in this case. In the event of a significantly and quickly changing gradient of a roadway, no gradient is learnt due to the major change, although it should be learnt in this case.

An object of the invention involves providing a method for compensating for gradient influence when determining a reference velocity, which eliminates the prior art drawbacks.

### SUMMARY OF THE INVENTION

This object is achieved by a method includes determining a controller nominal torque (M_{Rnominal}) in a vehicle controller (1) from at least one actual wheel speed (v_{wheel-actual}) and one predefined nominal wheel speed (v_{wheel-nominal}), determining a feedback torque (M_{feedback}), which is proportional to an estimated roadway gradient (\dot{ω}_{wheel}−\dot{ω}_{longit.}), calculating an engine nominal torque (M_{Mnominal}) from the controller nominal torque (M_{Rnominal}) and the feedback torque (M_{feedback}), and sending the engine nominal torque (M_{Mnominal}) to a vehicle controlled system (2) for determining the actual wheel speed (v_{wheel-actual}) from the engine nominal torque (M_{Mnominal}).

The invention is described making reference to the only FIGURE.

It has been found in tests that the wheel patterns in the problematic maneuvers (slowly rising wheel slip; significantly and quickly changing gradient of the roadway), as described hereinabove, are similar to each other. In both cases, the wheel speed and, hence, also the wheel acceleration are higher than the measured vehicle acceleration or the vehicle acceleration expected for the prevailing engine torque, respectively. When driving downhill, for example, the additional wheel acceleration is the result of the down-hill force. On a low coefficient of friction, the wheel is accelerated due to an excessive torque, which could not be converted into additional vehicle acceleration (spinning wheel). It is necessary to separate the wheel patterns from each other in order to detect whether there is slowly rising wheel slip or a significantly and quickly changing gradient of the roadway. According to the invention, this is achieved in that the estimated roadway gradient is fed back to the engine torque.

### BRIEF DESCRIPTION OF THE DRAWING

In the drawing:

FIG. 1 illustrates a control circuit.

### DETAILED DESCRIPTION OF THE FIGURE

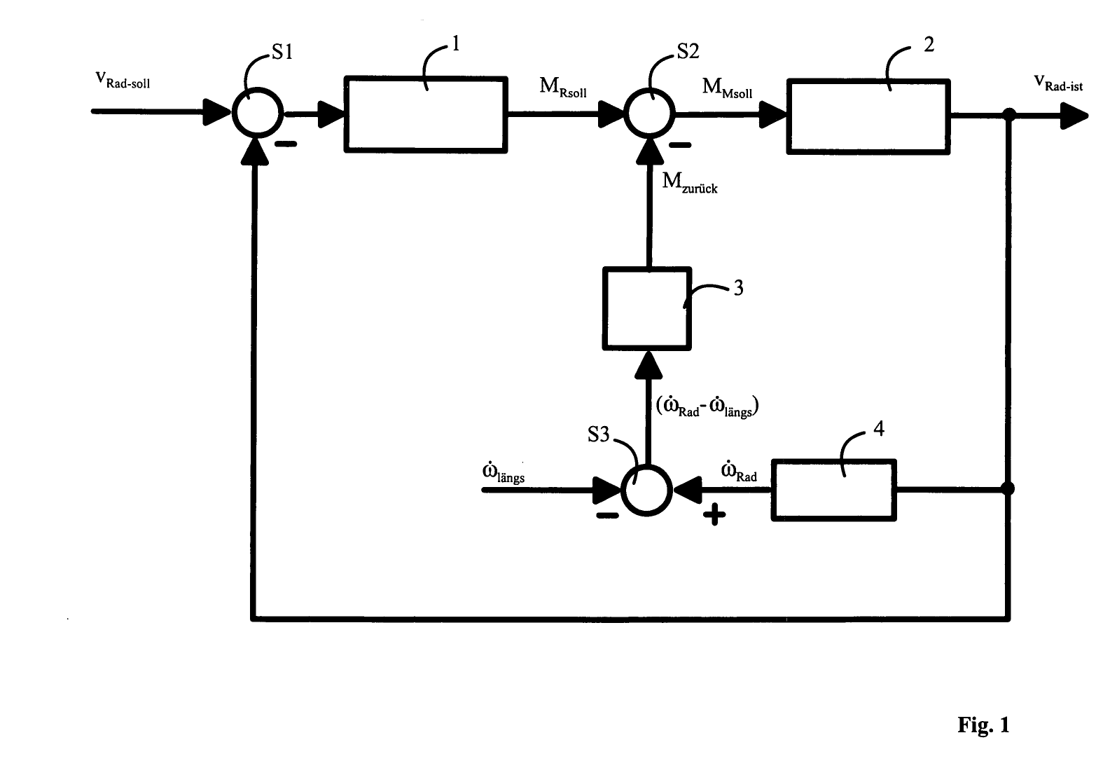

FIG. 1 illustrates a control circuit in which the roadway gradient is fed back to the engine torque. It is conventional practice that a nominal wheel speed v_{wheel-nominal}, which is combined in a first adder S1 with the actual wheel speed v_{wheel-actual}, is sent as an input quantity to a vehicle controller 1, e.g. a controller for traction slip control (TCS). This nominal wheel speed v_{wheel-nominal} depends on a predefined wheel slip value, for example. Depending on the input quantity, the vehicle controller 1 predefines a controller nominal torque M_{Rnominal} of a vehicle controlled system 2 as an input quantity, from which the actual wheel speed v_{wheel-actual} results as an output quantity. The estimated roadway gradient is fed back to the engine torque according to the invention. This is achieved in that a mathematical operation is used to determine the wheel acceleration \dot{ω}_{wheel} from the actual wheel speed v_{wheel-actual} in a block 4, the said wheel acceleration being combined with the longitudinal acceleration of the vehicle \dot{ω}_{longit.} in a third adder S3. The longitudinal acceleration \dot{ω}_{longit.} can be measured e.g. by means of sensors provided in this case. The connective operation of the longitudinal acceleration \dot{ω}_{longit.} with the wheel acceleration \dot{ω}_{wheel} achieves the estimated roadway gradient (\dot{ω}_{wheel}−\dot{ω}_{longit.}), which is combined in an amplification block 3 with an amplification factor K, with the result of a feedback torque M_{feedback}. From this feedback torque M_{ref} and the controller nominal torque M_{Rnominal}, an engine nominal torque M_{Mnominal} is determined in a second adder S2 and sent to the vehicle controlled system 2 as an input quantity for determining the actual wheel speed v_{wheel-actual}.

The amplification factor K in the feedback operation is rated in such a manner that the feedback torque M_{feedback} forces the wheels on a low coefficient of friction to reverse (condition 1) in a reliable manner, without this fact being noticed in the event of gradient changes of a roadway (condition 2). The term ‘reverse’ is to imply that the slip on the wheels diminishes, whereby spinning of the wheel is reduced or eliminated, respectively. To reach this objective, the excessive torque, which cannot be transferred, is compensated by the feedback operation. The currently prevailing mass of inertia of the power train is used as a value of the amplification factor K.

For the purpose of explanation, a maneuver will be assumed hereinbelow, where a vehicle with growing wheel slip is riding from a plane to a downgrade.

Condition 1 is satisfied when the excessive torque ΔM, causing the wheels to lose road contact,
ΔM=J*(\dot{ω}_{wheel}−\dot{ω}_{longit.}−\dot{ω}_{RA}),
is completely compensated. In this case, J refers to the mass of inertia, \dot{ω}_{wheel} refers to the wheel acceleration, \dot{ω}_{longit.} refers to the longitudinal acceleration, \dot{ω}_{RA} refers to the genuine gradient and (\dot{ω}_{wheel}−\dot{ω}_{longit.}) to the estimated gradient. With an amplification factor K of
K=−J
this excessive torque ΔM is overcompensated by J*\dot{ω}_{RA}, so that \dot{ω}_{wheel} converges towards (\dot{ω}_{longit.}+\dot{ω}_{RA}) and (\dot{ω}_{wheel}−\dot{ω}_{longit.}) towards \dot{ω}_{RA}. The estimated gradient (\dot{ω}_{wheel}−\dot{ω}_{longit.}) admittedly converges towards the genuine gradient \dot{ω}_{RA}, however, this is done at the expense of a lower rate of longitudinal acceleration \dot{ω}_{longit.} than would have been possible without the feedback operation. The longitudinal acceleration \dot{ω}_{longit.} then declines by Δ\dot{ω}_{longit.}. This decline can be estimated as follows by using the vehicle mass and the effective tire radius r_{eff}:
Δ\dot{ω}_{longit.}=ΔM/[J+m*r_{eff}²]=−J/[J+m*r_{eff}²]*\dot{ω}_{RA}.

The factor J/[J+m*r_{eff}²] being also known as rational inertia coefficient approximately ranges from 0.1 to 0.4 depending on the gear-shift. Thus, the change in the longitudinal acceleration Δ\dot{ω}_{longit.} amounts to roughly 10% to roughly 40% less than the genuine gradient \dot{ω}_{RA}. However, now as before, there is a rise in the vehicle acceleration due to the gradient change. If this rise is still high enough, the loss in acceleration is assumed to be unnoticed by the driver. Hence, condition 2 is likewise satisfied.

It is frequently sufficient to simply detect whether the wheels exhibit rising wheel slip, or whether the sudden wheel acceleration is the result of a gradient change of the roadway. This fact, too, can be detected in the feedback operation according to the invention. The feedback operation causes decline of the estimated gradient (\dot{ω}_{wheel}−\dot{ω}_{longit.}) in the case of wheels with rising wheel slip. In a transition into a downgrade without wheels with rising wheel slip, the feedback operation has no influence on the estimated gradient (\dot{ω}_{wheel}−\dot{ω}_{longit.}). Therefore, the change of the gradient in an active feedback operation is a feature of the driving situation: wheels losing road contact or change in gradient.

The above example shows that the feedback operation causes the estimated gradient (\dot{ω}_{wheel}−\dot{ω}_{longit.}) to converge towards the genuine gradient \dot{ω}_{RA}, with the vehicle, admittedly, losing part of the possible acceleration in consequence of the feedback operation. However, the gain in acceleration is nevertheless positive. The loss of possible vehicle acceleration in percent is assumed to be scarcely resolvable for the driver depending on the gearshift. Apart therefrom, the active feedback operation permits using the change of the gradient as a feature for the driving situation: wheels losing road contact or change in gradient.

1-7. (canceled)

8. A method for compensating for gradient influence when determining a reference velocity in motor vehicles, the method comprising:
determining a controller nominal torque (M_{Rnominal}) in a vehicle controller (1) from at least one actual wheel speed (v_{wheel-actual}) and one predefined nominal wheel speed (v_{wheel-nominal});
determining a feedback torque (M_{feedback}), which is proportional to an estimated roadway gradient (\dot{ω}_{wheel}−\dot{ω}_{longit.});
calculating an engine nominal torque (M_{Mnominal}) from the controller nominal torque (M_{Rnominal}) and the feedback torque (M_{feedback}); and
sending the engine nominal torque (M_{Mnominal}) to a vehicle controlled system (2) for determining the actual wheel speed (v_{wheel-actual}) from the engine nominal torque (M_{Mnominal}).

9. A method according to claim 8, wherein the feedback torque (M_{feedback}) is determined from the estimated roadway gradient (\dot{ω}_{wheel}−\dot{ω}_{longit.}) and an amplification factor K.

10. A method according to claim 9, wherein the estimated roadway gradient (\dot{ω}_{wheel}−\dot{ω}_{longit.}) is determined from a wheel acceleration (\dot{ω}_{wheel}) and a vehicle longitudinal acceleration (\dot{ω}_{longit.}).

11. A method according to claim 10, wherein the wheel acceleration (\dot{ω}_{wheel}) is determined from the wheel speed (v_{wheel}) using a mathematical operation.

12. A method according to claim 10, wherein the longitudinal acceleration (\dot{ω}_{longit.}) is measured using sensors.

13. A method according to claim 9, wherein the currently prevailing mass of inertia of the drive train of the vehicle is used as a value of the amplification factor.

14. A computer program product comprising:
a defined algorithm comprising a method for compensating for gradient influence when determining a reference velocity in motor vehicles, the method comprising:
determining a controller nominal torque (M_{Rnominal}) in a vehicle controller (1) from at least one actual wheel speed (v_{wheel-actual}) and one predefined nominal wheel speed (v_{wheel-nominal});
determining a feedback torque (M_{feedback}), which is proportional to an estimated roadway gradient (\dot{ω}_{wheel}−\dot{ω}_{longit.});
calculating an engine nominal torque (M_{Mnominal}) from the controller nominal torque (M_{Rnominal}) and the feedback torque (M_{feedback}); and
sending the engine nominal torque (M_{Mnominal}) to a vehicle controlled system (2) for determining the actual wheel speed (v_{wheel-actual}) from the engine nominal torque (M_{Mnominal}).
